(19) United States
(12) Patent Application Publication
(10) Pub. No.: US 2008/0272165 A1
(43) Pub. Date: Nov. 6, 2008

(54) LOAD-CARRYING SYSTEM FOR OFF-ROAD VEHICLES

(76) Inventor: Michael McMillan, Caldwell, ID (US)

Correspondence Address: PEDERSEN & COMPANY, PLLC, P.O. BOX 2666, BOISE, ID, 83701, US

(21) Appl. No.: 12/174,610

(22) Filed: Jul. 16, 2008

Related U.S. Application Data
(63) Continuation-in-part of application No. 11/622,353, filed on Jan. 11, 2007.

(51) Int. Cl. B60R 9/02

(52) U.S. Cl. 224/408

(57) ABSTRACT

A load carrier for an off-road vehicle, such as an ATV or snowmobile, includes a generally horizontal platform and moveable article-mounts that may be adjustably fixed in position underneath and/or on top of said platform to receive various pieces of cargo. The article-mounts may receive and anchor elongated objects such as snowboards, skis, and rifle cases, preferably in a horizontal orientation generally parallel to the length of the vehicle. Preferably, a substantial portion of the platform upper surface is on a single, substantially horizontal plane and is available for multiple of said article-mounts, while another portion is recessed for receiving smaller, shorter, or more regularly-shaped objects. In a first group of embodiments, moveable article-mounts are underneath the platform, for example, by connection of a rail or other mounting portion of the article-mount to the underside and/or side edge of the platform. In a second group of embodiments, movable article-mounts are connected to the upper surface of the platform, and preferably include one or more paddles, posts, or other upright members. The above-platform article-mounts are preferably swivelable on an axis perpendicular to the upper surface of the platform. Latches and/or clamping features may secure the cargo item to or between the paddles, posts, or other upright members.

This application is a continuation-in-part of application Ser. No. 11/622,353, filed Jan. 11, 2007 and entitled “Load Carrying System For Motor Vehicles,” the entire disclosure of which is hereby incorporated herein by this reference.

### BACKGROUND OF THE INVENTION

1. Field of the Invention

The present invention relates to a load carrier designed for attachment to off-road vehicles, in particular snowmobiles and all-terrain vehicles (ATVs). The load carrier accepts detachable article-carrying devices, designed to transport longer, odd shaped items including snowboards, skis, shovels, and rifle cases.

2. Related Art

Improvements in the design and performance of off-road vehicles over the years, in particular snowmobiles and ATVs, have enabled people greater access into remote areas to pursue outdoor recreation and occupational activities. Snowmobile and ATV users, including snowboarders, skiers, ice climbers and hunters, routinely transport a variety of cargo items to effectively support their backcountry activities and travel. A snowmobile or ATV operator can attach a gear-sled or cart in tow. These cargo sleds or carts are typically made of aluminum or Ultra-High-Molecular-Weight (UHMW) plastic. Towing a cargo sled or cart behind a snowmobile or ATV enables bulk loading and transport of heavy cargo items, but can also inhibit the operator's access, maneuverability and fuel efficiency.

There are many situations in which cargo loads are preferred, or need, to be attached directly to a snowmobile or ATV. This can be when transporting skis, snowboards, rifles, supplemental fuel cans, water jugs, sleeping and duffle bags, tents, toolboxes, clothing, food containers, and safety gear including shovels, bound rope, medical supplies and search and rescue equipment.

Mechanical and environmental challenges for off-road vehicle cargo-carrying products include the weight of the load carrier relative to its strength and rigidity, its load balance capabilities and cargo configuration limitations, and potential damage to a user's vehicle, from the stress of carrying cargo under normal operating conditions. There is also the risk of cargo items becoming detached as riders navigate, often at high speeds, uneven terrain, including waterways, forests, culverts and mountains.

A number of snowmobile cargo baskets and article carriers have been created over the years. Some are open containers formed of rod, tube or wire pieces joined or welded together. This type of load carrier typically has four sides and a floor section, so that the load carrier may be described as a basket-style carrier. These carriers may require brackets, clamps or other mounting hardware to hold cargo items within the recessed cargo area of the carrier or basket. These baskets are typically detachable, and mounted to the rear portion of a vehicle chassis, tunnel, cargo platform or hull, using hardware such as bolts or clamps, or other restraint device. Basket mounting and cargo securing hardware can include straps, bolts, buckles, brackets, and also custom molded plastic and metal pieces. These basket-style load carriers are typically designed to fit on the flat, rear cargo platform located behind the seat of the snowmobile. Longer items such as skis, snowboards, and rifle cases can be positioned upright in the basket. Bulk cargo items typically transported inside these baskets include clothing, boots, water jugs, toolboxes and fuel cans. Some snowmobiles and ATVs are designed with customized cargo holds integrated as part of their design infrastructures, typically at the vehicle front or rear.

Another popular load carrier for snowmobiles and ATVs is the cargo rack-frame assembly, relatively lightweight in comparison to basket-style racks. Rack-frame assemblies are typically flat, short pieces of metal or plastic, joined together to form cross-member or upright-member, substantially-vertical, scaffold-style support systems. The racks/frames of such systems are substantially open, with significant spaces between cross-members and/or upright-members. Cargo articles carried by these types of load carriers are typically snowboards and skis. In many cases, the rider assembles the rack-frame before mounting it to a particular snowmobile. Straps, brackets, buckles or custom-molded hardware commonly accompany rack-frame assemblies.

Rack-frame assemblies are designed for removable attachment to various locations on the tunnel, body or chassis of the snowmobile or ATV. These stress points suffer wear and damage under normal operating conditions.

The demanding operational forces exerted upon these cargo carrying products, and the value of items being carried, and that of the vehicles themselves, are such that many riders today seek better solutions to their cargo-carrying problems. The load carriers described above have certain limitations, and a different type of load carrying system is needed to meet the needs of many off-road vehicle users, in particularly snowmobile and ATV users.

### SUMMARY OF INVENTION

The invention comprises a load carrier for an off-road vehicle, such as an ATV or snowmobile, wherein the load carrier comprises a generally horizontal platform for connection to said off-road vehicle, and moveable article-mounts that may be adjustably fixed in position underneath and/or on top of said platform to receive various cargo articles, objects, or items (hereafter called “items” for simplicity) for transport. Said article-mounts may be specially adapted to receive and anchor elongated objects such as snowboards, skis, and rifle cases, preferably in a horizontal or generally horizontal orientation parallel or generally parallel to the length of the vehicle. Preferably, a substantial portion of the platform upper surface is on a single, substantially horizontal plane and is available for multiple of said article-mounts, while another portion is recessed for receiving smaller, shorter, or more regularly-shaped objects.

A first group of embodiments comprises a plurality of moveable article-mounts that may be mounted underneath the platform (also called, “below-platform” article-mounts), for example, by connection of a rail or other mounting portion of the article-mount to the underside and/or side edge of the platform. One preferred below-platform article-mount is a generally vertical cradle extending downward relative to the platform, wherein the cradle clamps objects such as a snowboard to the load carrier. Another preferred below-platform article-mount is a bracket that also extends downward relative to the platform and that comprises a generally horizontal slot for receiving skis or other elongated objects.

Each of the below-platform article-mounts may be moved to, and locked in, various locations along the underside and/or side edge of the platform, and, hence, in various locations preferably underneath the platform at or near side edges of the platform. The below-platform article-mounts are preferably adapted so that elongated cargo items held in the below-platform article-mounts are parallel, or generally parallel, to the length of the vehicle. This way, also, the elongated cargo items may be situated close to the vehicle in such a way that said cargo items do not extend transversely out beyond the outermost side extremity of the vehicle. Thus positioned, the cargo items are unlikely to catch on any terrain, trees, fences or other structure by which the vehicle is traveling, and load-balance and maneuverability are enhanced.

A second group of embodiments may comprise, in addition to or instead of below-platform article-mounts, one or more movable article-mounts connected to the upper surface of the platform (also called, “above-platform” article-mounts). The preferred above-platform article-mounts may be of the type called “post” or “paddle” systems that each comprise at least one upending arm, pole, post, panel, or other upwardly-protruding members. In preferred embodiments of the above-platform article-mounts, a set of generally vertical arms upends from a rotatable/swivelable plate, wherein the arms receive cargo items, optionally with the assistance of latches and/or a clamping feature to hold the cargo item between the arms.

The preferred above-platform, upwardly-extending article-mounts may be moved to, swiveled, and locked in, various locations and positions on or near the upper surface of the platform, with said locations and positions being provided so that the elongated cargo items extend parallel or generally parallel to the length of the vehicle, and close to the vehicle, in such a way that said cargo items do not extend transversely out beyond the outermost side extremity of the vehicle. While elongated cargo in these above-platform article-mounts may not be exactly parallel to the length of the vehicle, in order to avoid the driver and the driver's seat, the cargo preferably will be substantially parallel, for example, at, or less than, 45 degrees from parallel to said length. This way, the cargo items are unlikely to catch on any terrain, trees, fences or other structure by which the vehicle is traveling, and load-balance and maneuverability are enhanced.

The load carrier may be rectangular or generally rectangular, so that the side edges may be straight and parallel/generally-parallel to the length of the vehicle. Alternative load carriers may be non-rectangular and/or may not have straight side edges; for example, such alternative load carriers may be oval, egg-shaped, other shapes that do not have straight side edges, or shapes that have both straight and curved side edges. Generally oval or other non-straight-edge platforms may have the advantage of being strong and resistant to bending under extreme force, for example, when the user uses the load carrier as a hand-hold when pulling the rear of the vehicle out of a snow-bank. Both rectangular and non-rectangular load carriers may have side edges or side edge portions, or other structure underneath the upper platform, to which below-platform article-mounts may be connected, preferably with the cargo being parallel or generally parallel to the vehicle length so that it is less likely to catch on terrain, trees, fences or other structure by which the vehicle is traveling.

The load carrier may be bolted or otherwise fastened to various structures on the vehicle, for example, to the vehicle frame or “tunnel” behind the rider's seat. Downwardly-depending struts may be used, for example, extending downward from at or near the rear of the load carrier for being strapped or otherwise fastened to a rear portion of the vehicle, for example, a rear bumper or grab bar of the vehicle.

The preferred load carrier is not a frame structure in that it is not a set of horizontal or vertical bars or wires, wherein spaces between said bars or wires are large relative to the width of the bars or wires. Rather, the main body of the preferred load carrier is a generally horizontal platform that may have cutouts and holes, but is more solid and continuous than it is open, to provide strength, durability, and sure and deliberate placement and locking of article-mounts for holding cargo. Said cutouts and holes in said platform provide drainage, lighten the load carrier, and/or provide apertures for bolts or other fasteners to connect the load carrier to the vehicle, to connect the article-mounts to the platform or to rails/channels or other apparatus formed or provided underneath the platform, and/or to receive hooks or ties for tying the cargo to the platform and/or to the article-mounts.

### BRIEF DESCRIPTION OF THE DRAWINGS

FIG. 1 is a rear, right-side perspective view of one embodiment of a load carrier according to the invention, attached to a snowmobile, wherein the load carrier platform is generally rectangular and wherein the load carrier comprises multiple below-platform article-mounts that are holding a snowboard and skis.

FIG. 2 is a rear, left-side perspective view of the load carrier and snowmobile of FIG. 1.

FIG. 3 is a top view of the load carrier and snowmobile of FIGS. 1 and 2.

FIG. 4 is a right side view of the load carrier and snowmobile of FIGS. 1-3.

FIG. 5 is a left side view of the load carrier and snowmobile of FIGS. 1-4.

FIG. 6 is a front-left perspective view of the load carrier of FIGS. 1-5, with no cargo attached.

FIG. 7 is a left side view of the load carrier of FIGS. 1-6.

FIG. 8 is a rear-right view of the load carrier of FIGS. 1-7.

FIG. 9 is a right side view of the load carrier of FIGS. 1-8.

FIG. 10 is a front view of the load carrier of FIGS. 1-9.

FIG. 11 is a rear view of the load carrier of FIGS. 1-10.

FIG. 12 is a top view of the load carrier of FIGS. 1-11.

FIG. 13 is a bottom view of the load carrier of FIGS. 1-12.

FIG. 14 is a right, front, exploded view of the load carrier of FIGS. 1-13.

FIG. 15 is a left, front, exploded view of the load carrier of FIGS. 1-14.

FIG. 16 is a rear, left-side perspective view of another embodiment of a load carrier according to the invention, attached to a snowmobile, wherein the load carrier platform is generally oval and wherein the load carrier comprises both below-platform and above-platform article-mounts, which are holding a shovel and a snowboard, respectively.

FIG. 17 is a rear, left-side perspective view of the load carrier platform of the embodiment of FIG. 16, with an alternative set of cargo article-mounts, so that both a snowboard and skis are held above the platform of the load carrier.

FIG. 17A is a top view of the embodiment of FIG. 17, removed from the snowmobile and with the above-platform article-mounts rotated and fixed in positions that place the skis and snowboard in a generally parallel, V-shaped, orientation that would be generally parallel to the snowmobile length.

FIG. 18 is a rear, left-side perspective view of the load carrier platform of the embodiment of FIGS. 16 and 17, with yet another set of above-platform article-mounts, for holding two sets of skis.

FIG. 19 is a front, left-side perspective view of the load carrier of FIG. 17, removed from the snowmobile and with cargo removed.

FIG. 20 is a bottom, rear perspective view of the load carrier of FIGS. 17 and 19.

FIG. 21 is a rear, exploded, perspective view of the load carrier of FIGS. 17, 19 and 20.

### DETAILED DESCRIPTION OF THE PREFERRED EMBODIMENTS

Referring to the Figures, there are shown multiple, but not the only, embodiments of the invented load carrier for off-road vehicles. The load carrier preferably may be connected to a vehicle as an after-market/retrofit accessory, but, alternatively, may be provided as an original equipment manufacture (OEM) feature of the vehicle.

While various baskets and frames have been designed for carrying cargo on snowmobiles or ATVs, such baskets and frames share the common feature of consisting essentially of substantially vertical, upward-extending basket walls or frames/scaffolds. The invented load carrier, on the other hand, features a main body with a generally and substantially horizontal and flat platform surface, with cargo clamped to said main body by use of various embodiments of article-mounts, also called “article-carriers.” The main body may also have a recess to contain smaller objects.

Bolts or other fasteners may be used to join the load carrier to the vehicle rear tunnel surface, or cargo plate, providing secure and flush attachment of the load carrier to the motor vehicle. For example, in the case of a snowmobile, the load carrier may be mounted behind the vehicle operator on the rear, flat cargo area of the tunnel or frame of the vehicle. Bolts may extend through corners of a floor panel of a recessed portion of the load carrier platform and into said rear tunnel surface.

Threaded inserts that accept bolts can be mounted to the motor vehicle tunnel, frame, chassis or underside, if desired, to facilitate ready attachment and removal of the load carrier to and from the motor vehicle. Mounting the inserts to the vehicle enables one-handed operation, because the user need not manipulate loose/unattached nuts for said bolts. Hex cap bolts and cooperating mounted, threaded inserts, comprise one type of preferred mounting hardware. Care must be taken when drilling holes into any vehicle during accessory product mounting applications.

The load carrier preferably further includes at least one rear strut assembly, preferably detachable and of adjustable height, which fastens the rear, underside portion of the load carrier platform to the vehicle rear bumper, or ‘grab bar’, as in the case of snowmobiles and ATVs. A hose clamp or similar mechanism is used to fasten the rear strut foot of the rear strut assembly to the vehicle bumper or ‘grab bar’.

The preferred embodiments of the present invention routinely and safely support the weight, mass, and stress of long, awkward, relatively heavy cargo items routinely transported upon off-road vehicles. The load carrier and inter-fitting article mounting/carrying devices are easy to use, enabling operators to balance, position, and secure cargo loads to their particular vehicles, based upon their cargo carrying needs and imminent driving conditions. The load carrying system of the present invention can carry multiple combinations of cargo items at one time, or remain low profile when empty.

Cargo items, including skis, snowboards, rifle cases, and shovels, can be suspended below the platform of the load carrier and/or carried upon the load carrier top surface. Both the below-platform and above-platform article/item carriers or “article-mounts” may be used to suspend or support, respectively, heavy, awkward cargo items; the above-platform article-mounts have a particular advantage in that they reside on/above the relatively large, broad platform upper surface.

In the preferred below-platform article-mounts, as will be fully understood by viewing the embodiments described later in this document, a solid and secure attachment of cargo items is achieved by cradling and suspending the cargo items below and preferably beside the platform. Such below-platform article-mounts may comprise latched hooks, brackets, or other cradling devices in which the cargo is captured in ways that prevent twisting or swinging of the cargo relative to the platform and the vehicle.

In the preferred above-platform article-mounts, as also will be fully understand by the embodiments described later in this document, a solid and secure attachment of the cargo items is achieved by binding the cargo items to a single post or paddle, or between multiple posts or paddles. Said cargo post(s)- and/or paddles(s)-based article-mounts may comprise, or consist of, a base plate and two upright parallel members, which may be called “towers,” “posts,” “paddles,” “arms,” or other names. The arms may be generally fin-shaped and have flat, relatively broad surfaces facing inward, to accept cargo items within the space created between the two arms. The base plate may include rigid tabs, or threaded passages, or smooth holes or passages, drilled or otherwise formed to accept separate pins, bolts, knobs, or a combination of these devices. Preferably, the base plate is mounted flush to the top surface of the load carrier platform and secured or locked underneath the floor panel using one or more pins, bolts, knobs, or padlocks, or combination of locking mechanisms and fasteners. Once a post- or paddle-type article-mount is mounted in place on the load carrier body, the user may secure or lock various cargo items to the arms, and/or the load carrier body directly using cinching and locking straps or other attachment devices. Securement or locking of cargo in the post or paddle article-mounts, as more fully described below, may be done utilizing latch and/or clamping features of the post- or paddle-type article-mounts.

Two or more post or paddle article-mounts may be aligned if necessary to secure longer items to the load carrier. The opposing arms may be manufactured to be fixed in relation to one another, or manufactured to be adjustable in proximity to one another, enabling the user to secure different sized cargo items firmly between the arms. For example, a track system on the base plate may allow for sliding and securing one or both arms closer to, or farther from, one another, similar to a vise system, to allow secure positioned of cargo items of various widths between the opposing arms.

The posts or paddles may include passages/holes of various sizes, lengths, and orientation, to serve as receiving holes for pins, bolts, or other latches, and/or as attachment sites for bungee hooks, straps, ropes, or other attachment devices, such as cinching cables. Alternatively, depending on the effectiveness of the latching and/or clamping features, bungee cords, straps, ropes and cables may not be necessary. The preferred clamping process is aided by the flexion properties of light metal or UHMW plastic and the use of mounting hardware, bolts and rubber-coated knobs to squeeze the slightly flexible and resilient arms together. Neoprene or rubber inserts, molded or cut into fitted pieces, insulates the interior areas of the posts and paddles, providing a snug fit of cargo items, and a protective buffer from sharp ski, pole or snowboard edges during transport. The boots and bindings of skis and snowboards also serve to prevent these items' lateral movement within their respective article-mounts. Examples of the preferred, but not the only, above-platform article-mounts, as well as the below-platform article-mounts, are described in more detail below.

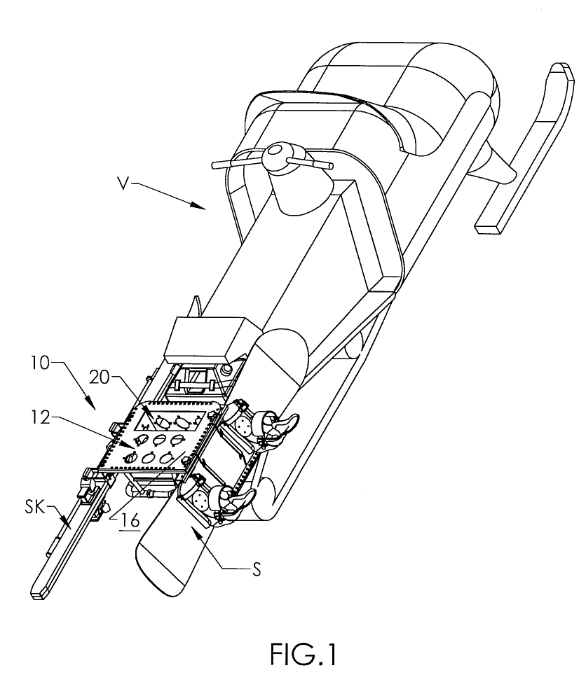

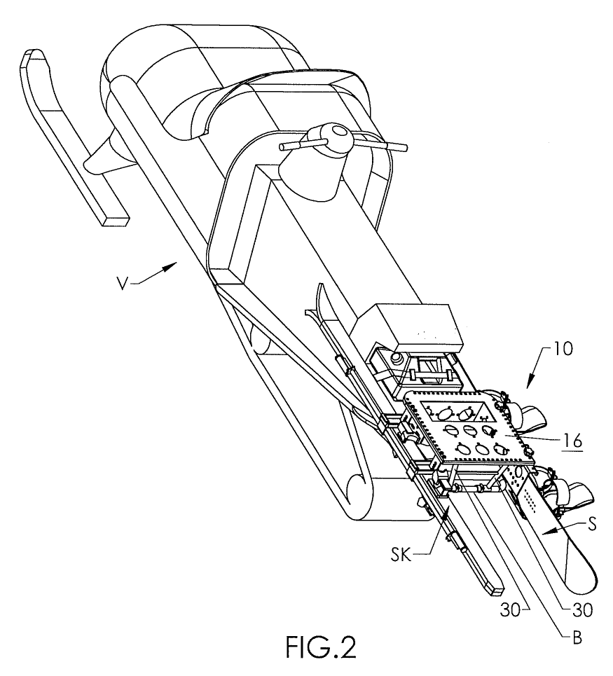

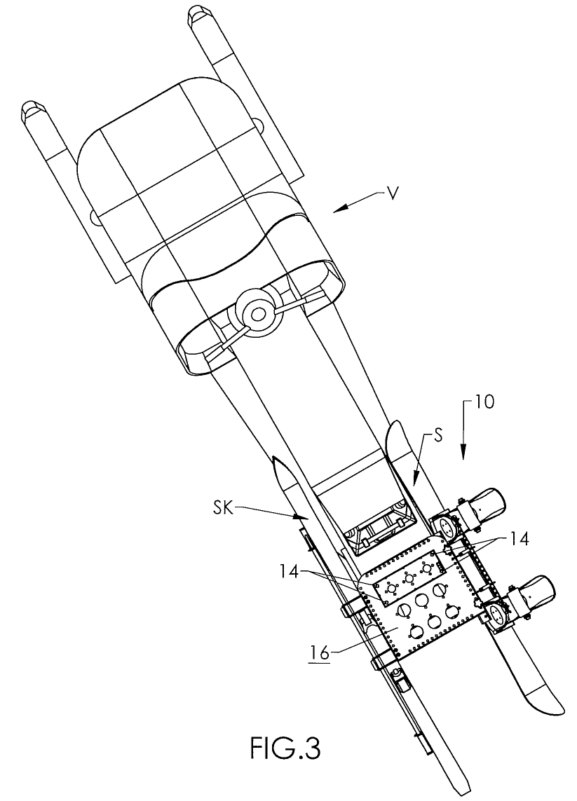

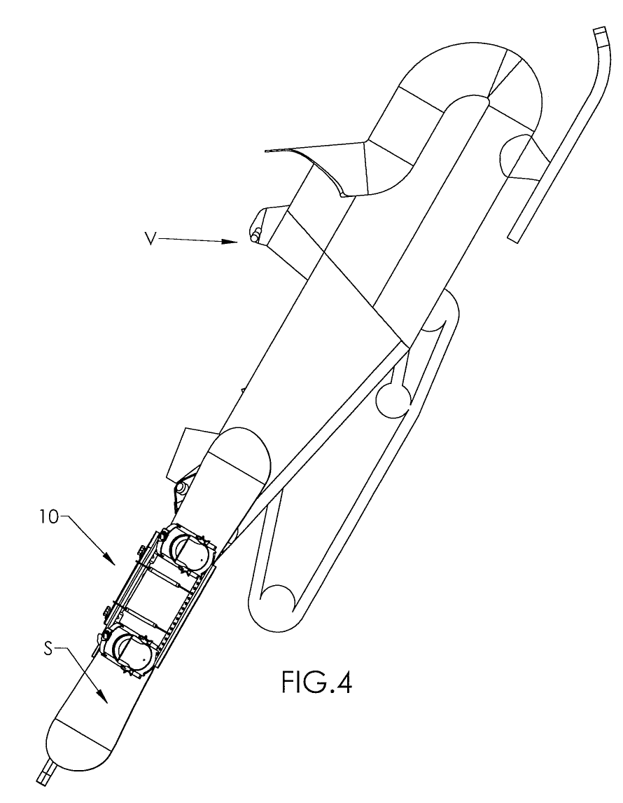

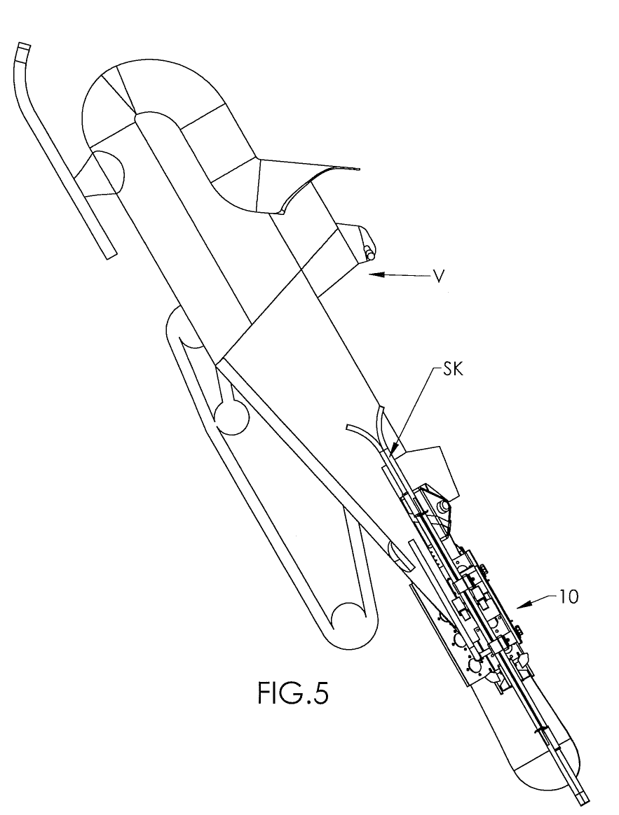

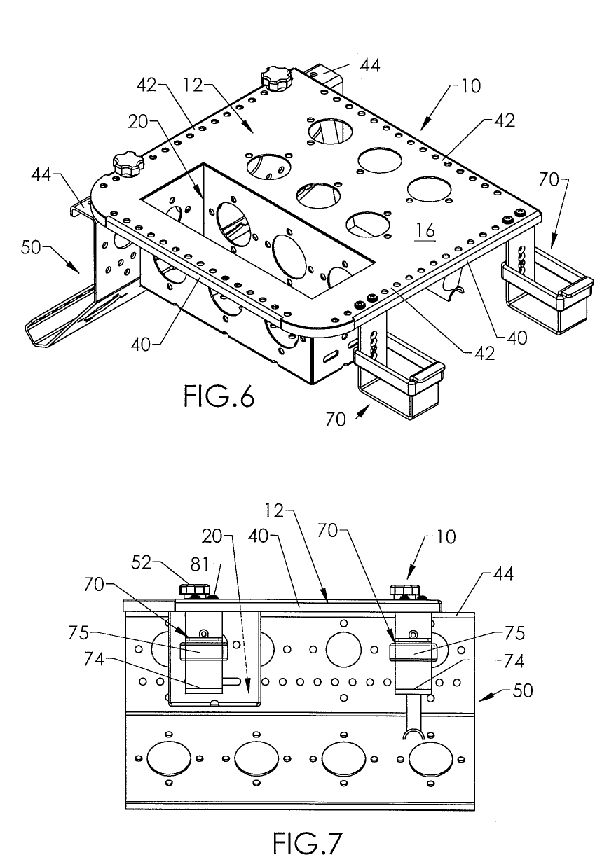

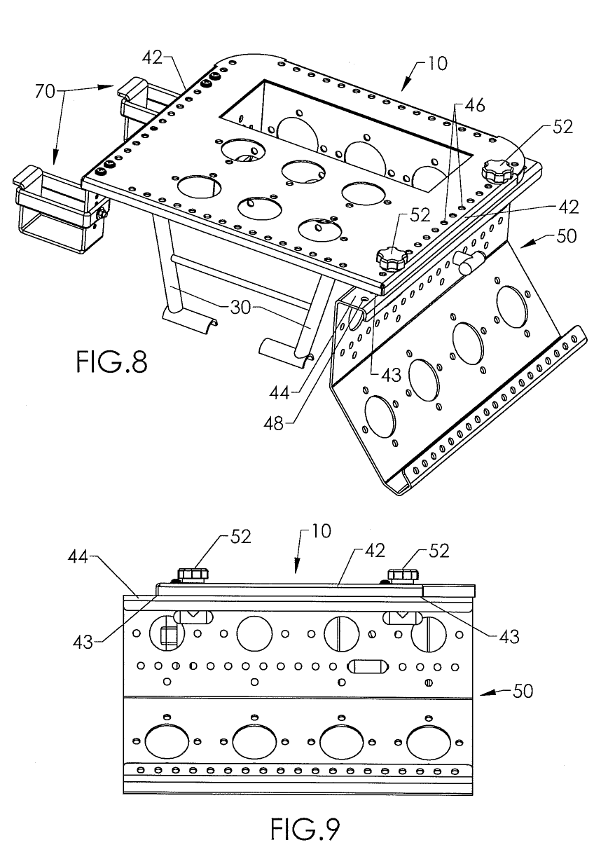

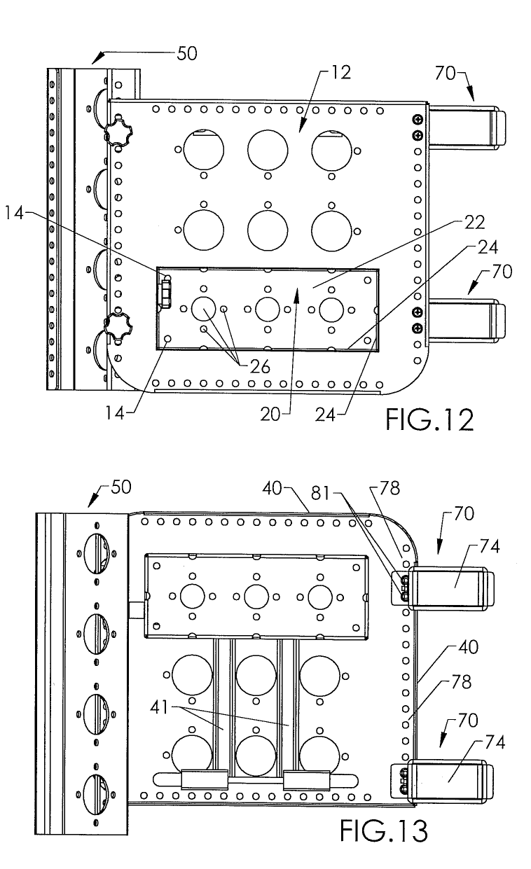

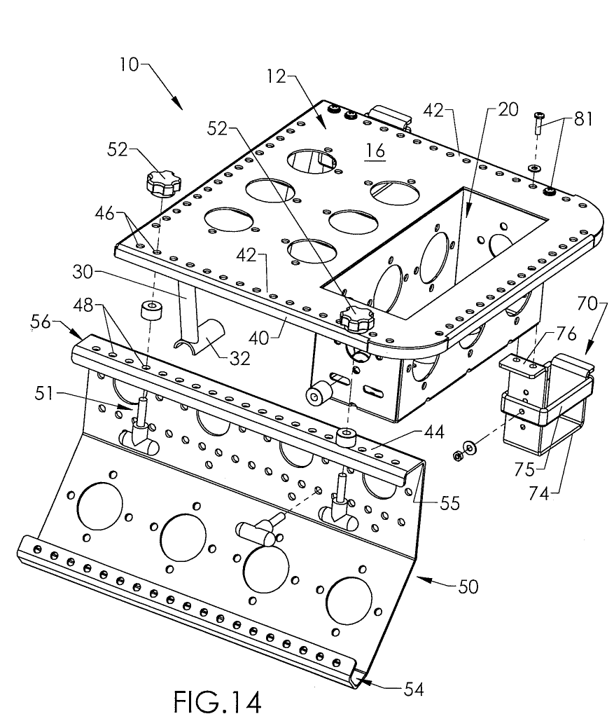

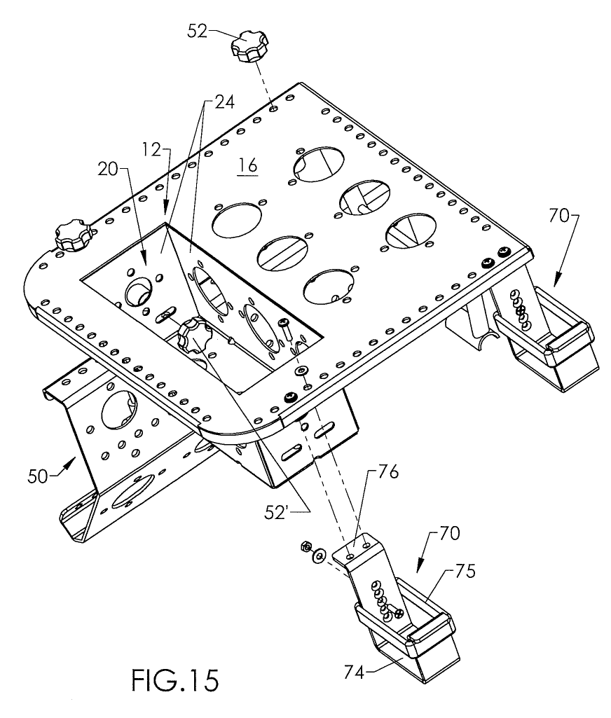

A first embodiment of the invention is shown in FIGS. 1-14, wherein the load carrier 10 connected to vehicle V comprises platform 12 that is generally rectangular in shape and that is bolted and strapped, or otherwise connected, to a vehicle V at multiple locations. Preferably, the platform 12 is bolted to the rear of the vehicle behind the driver seat by bolts extending through multiple holes in the platform 12 near the front of the load carrier 10; preferably, these bolts extend through holes 14 in the bottom wall of the recess 20 to reach a generally horizontal rear cargo plate of the snowmobile “tunnel.” Also, struts 30 with feet 32 extend downward from a rear region of the load carrier 10 and are strapped to the grab bar or bumper B, or other generally horizontal structure of the vehicle V. These or other connectors secure the load carrier to the vehicle V so that the platform 12 upper surface 16 is generally and preferably horizontal and so that it extends from a few inches behind the driver's seat to be directly above the bumper B or other rear extremity of the vehicle V. The right and left side edges of the load carrier 10 preferably do not extend out beyond the right and left outermost extremities of the vehicle.

One may understand from the drawings that the upper surface 16 is preferably a planar, flat, horizontal surface that may comprises one or more recesses for receiving objects that have a base that fits into the recess. For example, a gas or supply bag or a grouping of smaller pieces of equipment may be set in a rectangular recess 20. Elongated objects such as snowboards, snowshoes, or skis are preferably attached by embodiments of the invented article-mounts, as will be further detailed below.

The recess 20 preferably has a bottom wall 22 and four portions of sidewall 24, with the recess 20 being about 4-8 inches deep. Holes 26 are provided to allow drainage of rain and snow, and connection points for bungee cords, cables, or other ties, bolts, or other fasteners.

An outer edge rim 40 may be provided as a portion of the side edge 42, to strengthen the platform and/or to serve as a portion of a rail or channel on the underside of the platform 12. The rim 40 may be formed by affixing or welding a ribbon of metal approximately one half to two inches in width, at preferably an angle of 90 degrees, to the perimeter of a metal platform, or may be molded at preferably 90 degrees to a plastic platform, for example. The rim 40, which increases rigidity of the load carrier platform 12, may be fitted with rubber trim, for example, reinforced by metal inserts, to prevent the edge of cutting skin, cables, ties or other objects.

The side edge 42 may comprises multiple portions and be various shapes, for example, in the embodiment portrayed in FIGS. 1-15, the side edge 42 comprises the flat platform outer perimeter edge plus the rim 40. However, the platform outer perimeter may be formed differently and/or other structures may be provided in addition to, or instead of, the rim 40. For example, the platform outer perimeter may be rolled, bent, or molded to preferably include a non-horizontal portion, or to otherwise be supplemented with reinforcing structure in order to strengthen the platform. A supplemental structure other than the generally flat rim 40, for example, could be a square-cross-section or U-cross-section member formed with, or added to, the perimeter edge of the platform. The rim and/or other supplemental structure may help prevent warping, bending, or other deforming of the platform, for example, during use with heavier cargo or during pulling or digging the vehicle and its load carrier out of snow.

Optionally, the load carrier may comprise additional reinforcement structure, such as hat channels, or bracing beams, welded or otherwise mounted alone or in series underneath the platform 12, for example the beams 41 shown to best advantage in FIG. 11. Typically, at least one hat channel or brace beam 41 spans the entire, or at least a substantially portion, of the load carrier underside. The hat channels or bracing beams increase the strength, rigidity, and durability of the load carrier.

The rim 40, or other supplemental side edge structure is beneficial for connection and stabilization of below-platform cargo-mounts. For example, rail-mount-type article-mounts may comprise top rails that abut against, and/or connect to, the rim 40 or other supplemental structure. Alternatively, the rim 40 or other supplemental side edge structure may form an outer perimeter wall defining a channel, underneath the platform and inward from said outer perimeter wall, into which the top rail of the cargo-mount may be inserted and connected.

One embodiment of snowboard mount is article-mount 50, which may be removeably connected to the platform 12, underneath a right portion of the side edge 42 of the platform 12 at any one of various locations along the length of said side edge 42. Each of the side edge 42 of the platform and the top rail 44 of the snowboard article-mount 50 has a row of multiple holes 46, 48 for receiving a fastener 51 with an easily-operated knob handle 52, or other fasteners, to connect the top rail to the side edge of the platform.

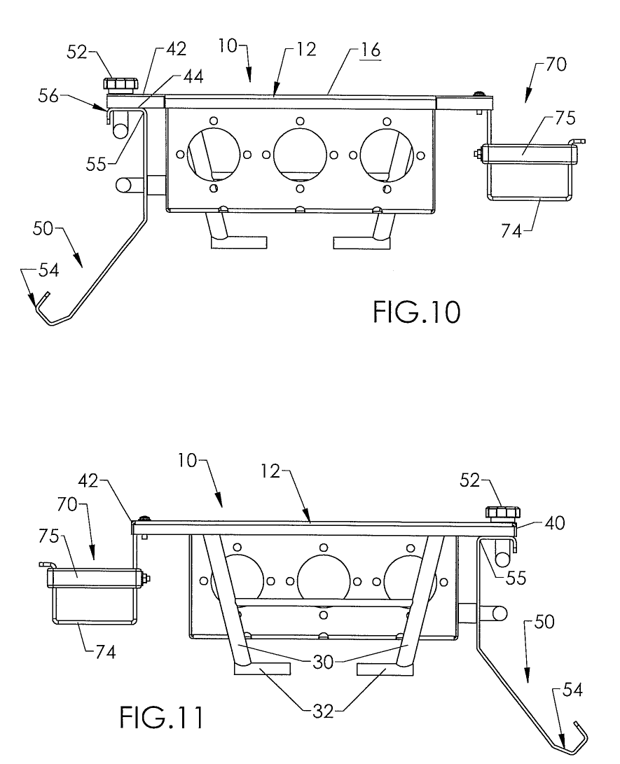

The article-mount 50 may be formed from a generally flat panel of aluminum or UHMW plastic, bent at about its transverse mid-line, creating a cradle or support for the snowboard being carried. Preferably, the panel is bent to form an acute angle of about 120-150 degrees, and more preferably about 135 degrees, as shown to best advantage in FIGS. 10 and 11. The article-mount 50 receives the snowboard S, so that the opposing snowboard edges rest in, and are captured between, a lower hook 54 and the top corner 55 of other surface of top hook 56. By unfastening the article-mount 50 from the platform 12, sliding the top rail 44 longitudinally (parallel to the length of top rail 44), and refastening the article-mount 50 to the platform 12 by means of the fastener/knob 51/52 in the holes 46, 48 of the rows of holes, the article-mount 50 may be adjusted to many positions along, and parallel to, the side edge 42. Thus, one may describe the mounting of article-mount 50 to platform 12 as a rail-mount. Further, for additional stability and security, an additional fastener with knob 52′ may extend through the sidewall 24 of the recess 20 to connect to the article-mount 50. The rows of multiples holes 46, 48 may be called “rail cutouts”, made, for example, by drilling ¼ to ½ inch holes along the load carrier top surface near the rim 40. One may note that there are many such rail cutouts all around the platform, reducing the weight of the load carrier, but adding to the versatility of the load carrier by providing many locations for rail-mounting of various article-mounts.

Other methods and apparatus for mounting bellow-platform article-mounts may be used. For example, it may be noted that the top rail 44 of article-mount 50 abuts against the bottom surface 43 of portions of the rim 40, because the top rail 44 is longer than the portion of the side edge 42 to which it is mounted and, therefore, because the top rail 44 extends past said portions of the rim 40/side edge 42. If, instead, the top rail 44 were shorter than the rim 40/side edge 42 portions to which it is mounted, said top rail 44 might fit in the recess/channel underneath the platform 12 just inward relative to the rim 40. Thus, the top rail 44 could be placed and locked in a recess/channel just inside the rim 40 of the platform, wherein the rim 40 would form the outer perimeter wall of the channel.

One embodiment of a rail-mounted ski article-mount, that is article-mount 70, has a bracket-shape more accommodating to secure skis, shovels, and rifle cases. Each rail-mounted ski article-mount 70 includes a suspension bracket forming a generally U-shaped cradle end 74 and a top rail end 76. The suspension bracket may be formed from a single plate or strip of metal, for example, that is bent right angles to form the cradle end 74 and the top rail end 76.

The top rail end 76 is shaped and sized to fit underneath the platform side edge 42, in the space/channel at the corner formed by the intersection of rim 40 with the platform 12. Thus, article-mount 70 connects to the load carrier underneath the platform and within the channel 78 using screws 81 or other fasteners through one or more top rail edge cutouts. As in the snowboard article-mount 50, a row of holes/cutouts is provided in each of the side edge 42 of the platform 12 and the top rail end 76 of the article-mount 70. This way, the user may slide and lock the article-mount 70 at several locations along the side edge 42 (that is, along the channel 78 underneath side edge 42), and the article-mount 70 may describe the device as “rail-mounted.” Preferably, two of the ski article-mounts 70 are used, so that the skis SK are held at two places along their lengths.

The suspension bracket cradle end 74 has a flat bottom wall upon which the skis SK rest, and a ring 75 or other latch, strap, clamp, cord, or restraint may be used to restrain the skis SK from bouncing up out of the cradle end 74. The ring 75 or other restraint may be adjustably locked in place over the skis SK, for example, by bolt 86 or another fastener, to lash, bind or otherwise secure the skis SK into place once they are positioned upon the cradle end 74 of the suspension bracket of the article-mount 70.

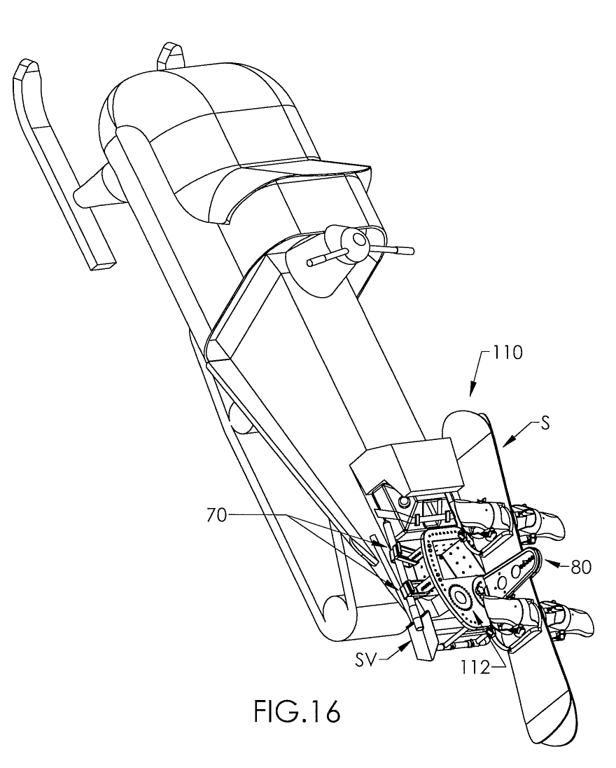

Rail-mounted article/item carriers/mounts, such as below-platform article-mounts 50 and 70, may be useful for snowboards and skis, as discussed above, as they “tuck” them generally out of the way underneath the platform 12, close to the vehicle and generally parallel to the length of the vehicle. Also, rail-mounted below-platform article-mount 50, 70 may be especially useful to haul shorter, lighter items, notably shovels (see FIG. 16, for example.)

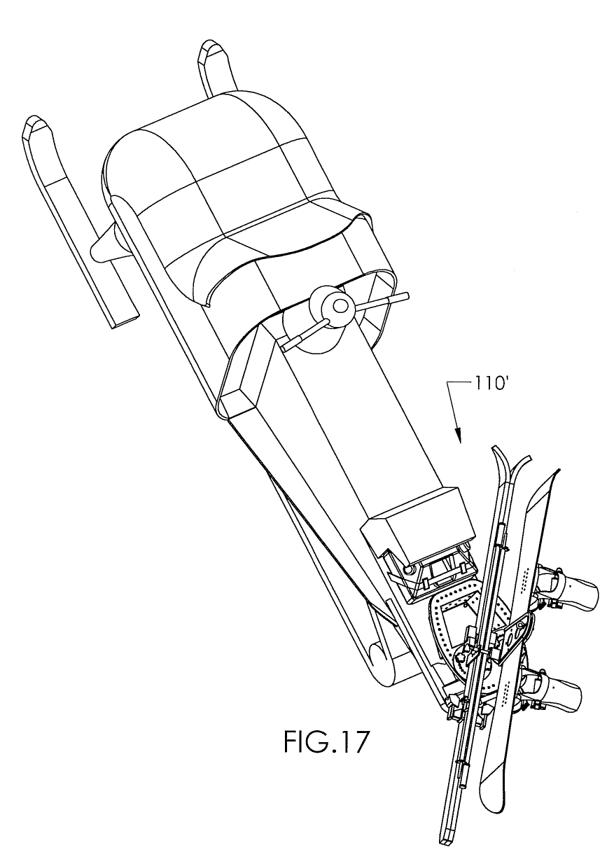

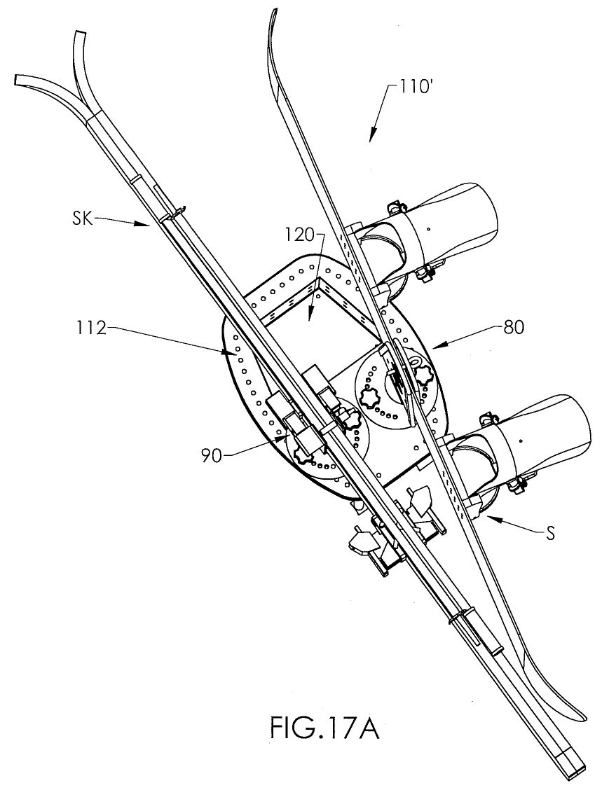

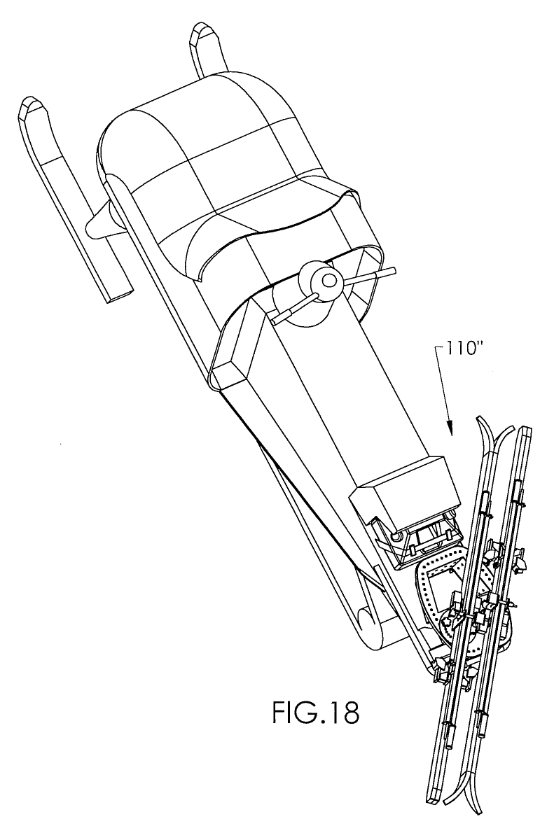

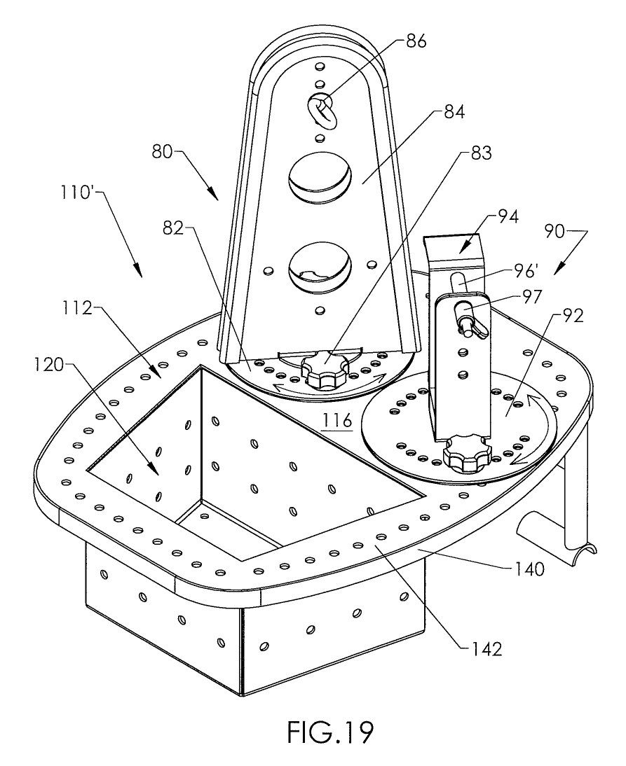

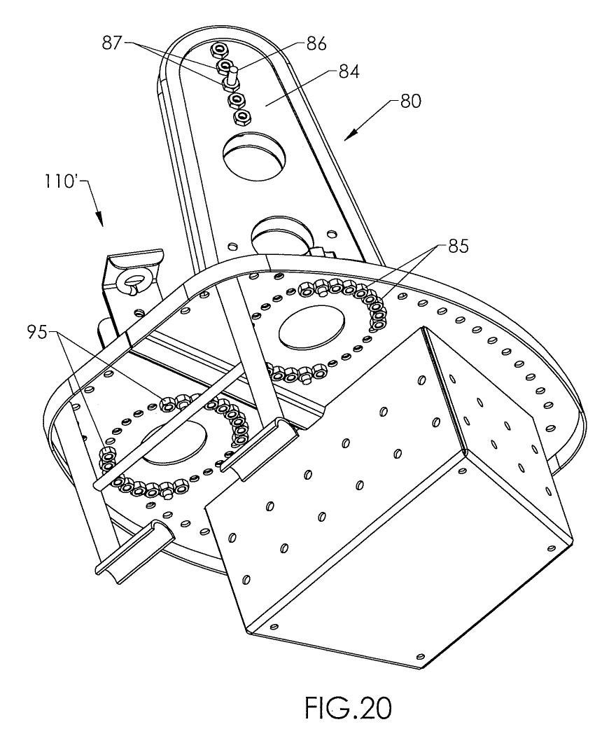

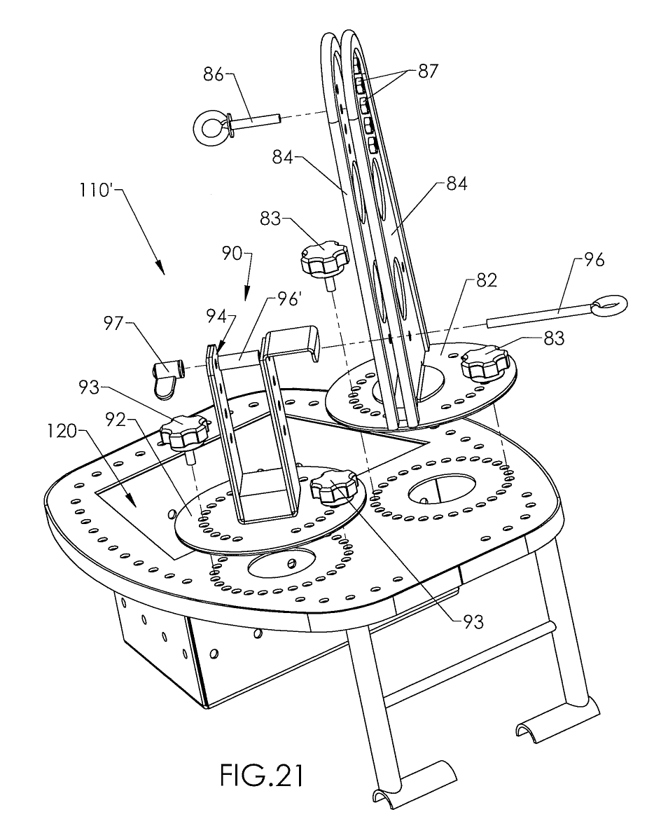

In addition to, or instead of, rail-mounted, below-platform article-mounts 50, 70, the load carrier may comprise above-platform article-mounts. While such above-platform article-mounts are not shown in FIGS. 1-15, it may be understood that the load carriers may comprise such above-platform article-mounts bolted or otherwise fastened to the platform 12 to protrude upwards from the platform 12. Such above-platform article-mounts may be bolted or otherwise fastened using any of the holes shown in the platform, for example, or alternative holes/apertures may be provided. Such above-platform article-mounts are preferably adjustable in location, for example, swivelable to face various directions relative to the vehicle length; preferred directions result in the cargo being parallel or generally parallel to the vehicle length, as discussed above. Examples of some, but not the only, above-platform article-mounts that may be used with many different platform embodiments are shown in the embodiments of FIGS. 16-21, as will be discussed in more detail below. See FIGS. 17 and 17A, for example, for illustrations of two of many different above-platform article-mount positions that are possible, wherein elongated cargo items may be carried in: (FIG. 17) parallel positions crossing the platform in the same direction; or (FIG. 17A) a generally V-shaped orientation wherein the front ends of the cargo items will be on opposite sides of the vehicle/seat.

As in the load carrier 10 of FIGS. 1-15, the platform 112 of load carriers 110, 110′, and 110″ of FIGS. 16-21 may accept different types of article-mounts, including different types of below-platform and above-platform article-mounts. Each of load carrier 110 in FIG. 16, load carrier 110′ in FIGS. 17, 17A, and 19-21, and load carrier 110″ has a generally planar platform 112 that is generally oblong in shape, but is fit with different embodiments of article-mounts (hence, the load carriers are given slightly different call-out numbers).

The platform 112 of the load carrier 110, 110′, 110″ includes holes and cutouts throughout its body that provide drainage and lighten the weight of the load carrier, in addition to serving as fastener holes for rail-mounted, below-platform article-mounts and/or for above-platform article-mounts. At least some of the cutouts are designed and positioned to accept above-platform cargo article-mounts, for example, ski and snowboard article-mounts that offer one-handed adjustable binding of cargo items within the article-mounts.

As will be understood by one of skill in the art in view of the discussion of rail-mounting for the load carrier 10, various styles of below-platform article-mounts may be effectively rail-mounted underneath the platform 112. In FIG. 16, two below-platform article-mounts 70 are provided along the left side edge of the load carrier 110, for holding a shovel SV. Because the left side edge of the load carrier platform 112 is curved, the two below-platform article-mounts 70 are at a slight angle to each other. The article-mounts 70 still effectively hold the shovel handle because the cradle ends (74) of these bracket-style article-mounts are sized with enough extra room to hold an elongated object even when the cradle ends are not aligned exactly parallel to each other.

The side edge of load carrier 110 is particularly conducive to receiving two bracket-style article-mounts 70, as the top rails of article-mounts 70 are shorter than the respective portions of the side edge and therefore may fit in the channel/space underneath the platform 112 just inward relative to the rim 140. However, it should be understood that load carrier 110 may also receive longer below-platform article-mounts, such as a snow-board article-mount 50 (see FIGS. 1-15). If the top rail of the below-platform article-mount 50 is longer than a respective portion of the side edge to which it is being mounted, then the top rail will typically abut against the bottom surface of portions of the rim 140 and the ends of the top rail may protrude beyond the side edge and/or rim of the platform 112. The curved side edges of the generally oval platforms 112 of load carriers 110, 110′, 110″ may affect the size and length especially of rail-mounted article-mounts, as it is not desirable, for safety, to have the ends of top-rail of the article-mounts protruding more than 1-3 inches from the side edge of the platform. While below-platform article-mounts are not portrayed in FIGS. 17-21, it will be understood that various types of said below-platform article-mounts may be used with load carrier 110, 110′, 110″.

Above-platform article-mounts 80 and 90, which may also be called “top-mounted” article-mounts, may be designed to swivel or rotate atop the load carrier platform, for example, by means a preferably flat, disc-shaped base plate 82, 92 that is rotatable on top of the platform 112 and lockable by hand-turnable bolts 83, 93. The user mounts the plates 82, 92 to the load carrier platform upper surface 116 in a location of choice, rotating the plates, which carry with them their respective arms or brackets, into the desired position, and then securing the plates with a rubber knob and bolt assembly, preferably comprising bolts 83, 93 and nuts 85, 95. Bolts 83, 93 extend through any of many holes (arranged in arcs) in plates 82, 92 to threadably connect to threaded nuts 85, 95. To facilitate one-handed mounting of the plates 82, 92 to the load carrier, the nuts 85, 95 are inserts that are welded or otherwise affixed to, or integral with, the load carrier platform underside to easily receive the bolts 83, 93 without manipulation of the nuts/inserts by the user. The nuts/inserts are preferably coarse-threaded metal fittings that easily accept a fastening bolt (bolts 83, 93) inserted from the load carrier topside and through the plates 82, 92 to secure the top-mounted article-carrier to the load carrier platform.

In one type of above-platform article-mount, for example, for top-mounting of snowboards, the top-mounted article-mount plate supports at least one, but preferably two, paddle-shaped uprights that are welded or otherwise fastened to the plate. Cargo items are placed alongside, or preferably between the opposing paddles, and secured into place by various mechanisms. A preferred embodiment of this type of article-mount is article-mount 80, wherein vertical paddles 84 upend from the plate 82 to receive cargo items between them, wherein a lockable pin 86 or other latch retains the cargo item in the paddles 84. The preferred threaded pin 86 is insertable through any of several sets of aligned holes in both paddles 84 and lockable by being screwed into the corresponding nuts 87. Nuts 87 are examples of threaded inserts fixed to an outer surface of one of the paddles 84, making installation of pin 86 a one-handed operation. The paddles 84 are slightly flexible, and so, by screwing-in the pin 86 until the paddles are pulled tightly together on each side of the cargo item, one may secure the cargo in said article-mount 80. Such tightening of the paddles 84 results in clamping of the cargo object by the paddles 84.

In another type of above-platform article-mount, for top-mounting skis, for example, at least one, and preferably two, opposing, upending posts are juxtaposed near each other to receive and secure the skis or other cargo. The preferred embodiment of this type is article-mount 90, which is mounted in a similar manner as article-mount 80, and so is also swivelable on or near the upper surface 116 of platform 112. Article-mount 90 comprises a generally U-shaped bracket 94, comprising two generally vertical arms serving as the upending posts, upending from the plate 92 to receive cargo objects between them. While the arms of bracket 94 are not as large as the paddles 84, the arms inner surfaces are preferably flat and planar.

A lockable pin 96 or other latch may be used to retain the cargo object between the arms of bracket 94. Lockable pin 96 may be inserted through both arms of bracket 94, through sleeve 96′ between the arms, and screwed into hand-turnable bolt 97. Sleeve 96′ may be used to prevent inward movement of the arms, and so allow the pin 96 and nut 97 combination to be tightened without squeezing the arms together. Alternatively, the sleeve 96′ may be removed or eliminated, and, then, tightening of the pin 96 and nut 97 combination may squeeze the arms together to clamp the cargo object between them. Sleeve 96′ and the pin 96 (or pin 96 only, if sleeve 96′ is eliminated) extend between the arms to close the top end of the bracket 94.

In each of article-mounts 80 and 90, the paddles 84, or arm of bracket 94, are spaced apart at their bottom ends a predetermined amount that is preferably not changeable or adjustable. Thus, while their top ends may be squeezable/tightenable in an inward direction, the bottom ends are typically not moveable relative to their respective plates 82, 92.

Preferably, the latches used to close and/or tighten the above-platform article-mounts 80, 90 are adjustable to varying heights on the arms 84 and bracket 94. This is done, in the preferred embodiments, by providing several sets of holes and nuts at various heights on the arms 84 and bracket 94, wherein the user selects which holes and nuts to use for a particular piece of cargo.

As alternatives to the paddles 84 and bracket 94 arms, other upending bars, posts, or panels may be used. Also, other plates and attachment methods may be used to connect the bars, posts or panels to the platform 112. Other latches and other latch height-adjustment methods may be used.

Thus it may be understood that the above-platform, upwardly-extending article-mounts may be moved to, swiveled, and locked in, various locations and positions on or near the upper surface of the platform. Said locations and positions are preferably provided so that the elongated cargo objects extend parallel or generally parallel to the length of the vehicle, and close to the vehicle, in such a way that said cargo objects do not extend transversely out beyond the outermost side extremity of the vehicle. Such article-mounts enable the user to position longer cargo items, such as snowboards or skis, clear of riders' bodies during operation, and in positions wherein the cargo items will not unbalance the vehicle. Long items can thus be positioned or aligned against or near the sides of the snowmobile or ATV, an advantageous feature when navigating uneven, brushy or wooded terrain because the cargo will not tend to catch on said brush, wood, or on other items or terrain being passed.

As shown in FIGS. 17 and 17A, for example, one may understand that the size and shape of the platform relative to the vehicle and the position and adjustment of the above-platform article-mounts may be adapted to allow carrying of cargo in various orientations to minimize problems with weight distribution and/or with cargo catching on terrain. Upon viewing FIGS. 17 and 17A, it will be understood that the above-platform article-mounts are each preferably independently swivelable/adjustable. Further, during manufacture, or by added adjustment features (not shown), the size and shape of the load carrier and its platform, and/or the placement of the article-mount holes and fasteners on the platform, may be adapted to allow swiveling/adjustment of the article-mounts to locations wherein the cargo items may be held generally parallel to each other and generally parallel to the vehicle length without abutting into the seat and the rider.

Post or paddle embodiments, such as article-mounts 80, 90, may also include design features to use these article-carrier components as improvised tools. For example, a paddle design can incorporate a detachable handle and fitted nosepiece, to use the paddle as a snow shovel. With two paddles detachable from their supporting base plate/disc, the paddles can incorporate lightweight snowshoe bindings into their flat, rigid body composition, with design features that make them suitable for use when walking on snow. Such a paddle design preferably includes a waffle pattern composition. In such an embodiment, a set of paddles could assist the off-road vehicle operator when traveling on foot.

As in the load carrier of FIGS. 1-15, the platform 112 of the load carriers of FIGS. 16-21 includes a recess 120. Recesses may be of varied size, shape, and depth. Preferably, recess side walls extend downward on all sides to a floor section, making the recessed portion usable as a cargo hold, for example, for odd-shaped items including water and fuel containers. Both of recesses 20, 120 are portrayed as open, uncovered recesses, but the open end (top) of the recesses may be fitted with a lid or cover with hinges, locks, hardware or other restraint device.

The preferred load carriers 10, 110, 110′, 110″ are made of sheet aluminum or mild steel, wherein the plate or panel members are of about 1/16 to ⅛ inch in thickness. However, the load carriers may instead be cast-molded from plastic, or made by other methods and from other materials or combinations of materials.

The load carrier is also susceptible to modification by the user for more specific applications. For example, the flat, planar properties of the load carrier upper surface provide an ideal platform for fastening cameras or tripod mounts, an appealing feature for photographers or videographers using a snowmobile on backcountry assignments.

Accompanying hardware for the present load carrier and its inter-fitting article carriers/mounts includes commonly available fasteners, such as rubber-coated knobs, bolts, stop nuts and threaded inserts, which are easily replaceable or improvised by the user if lost or damaged. The size, height, weight and capacity of the cargo platform, support struts, and recessed portion (if included), and article-mounts, can typically vary among different off-road vehicles, and are also determined by the cargo carrying needs of the operator.

Other embodiments of the invention will be apparent to one of skill in the art after reading this disclosure and viewing the drawings. Although this invention is described herein and in the drawings with reference to particular means, materials and embodiments, it is to be understood that the invention is not limited to these disclosed particulars, but extends instead to all equivalents within the scope of the following claims.

1. A load carrier for mounting to an off-road vehicle having a front, rear, and a length, the load carrier comprising:
a platform having at least a portion that is substantially flat and on a generally horizontal plane, and at least a portion that is recessed below said generally horizontal plane;
a first below-platform article-mount extending downward from the platform, said first below-platform article-mount comprising: a top end and a bottom end, wherein the top end is connected to the platform and has a generally horizontal length, wherein said top end and bottom end each comprise hooked portions facing each other for capturing a snowboard between said hooked portions for suspending the snowboard from the platform in an orientation generally parallel to a length of the vehicle, and wherein the top end is adjustably connected to the platform so that the first below-platform article-mount is horizontally adjustable relative to the platform in a direction parallel to the length of the top end.

2. The load carrier of claim 1, further comprising a second below-platform article-mount comprising a bracket having a top rail end adjustably connected to the platform and extending down from the platform, said bracket further having a lower cradle end with a horizontal wall for suspending a cargo item below the platform.

3. The load carrier of claim 2 comprising a total of two of said second below-platform article-mounts connected to said platform and spaced apart from each other underneath the platform so that said two of the second below-platform article-mounts are adapted to opposite ends of an elongated cargo item.

4. The load carrier of claim 1, wherein said first below-platform article-mount is a plate bent at a middle line to an acute angle and also bent at opposite edges to form said hooked portions.

5. The load carrier of claim 1, further comprising a first above-platform article-mount connected to an upper surface of said platform so that the first above-platform article-mount is swivelable on said upper surface, wherein said first above-platform article-mount comprises two parallel, upending paddles having a vertical space between them for receiving a cargo item.

6. The load carrier of claim 5, wherein said first above-platform article-mount comprises a plate that is at or near the upper surface of the platform and to which said paddles are attached, wherein the plate is adjustably fixed to the platform by at least one bolt extending through at least one hole in the plate and into any of a plurality of holes in said platform, and wherein the plate, when unbolted from the platform, is rotatable in a horizontal plane to swivel said above-platform article-mount on said upper surface.

7. The load carrier of claim 5, further comprising a second above-platform article-mount connected to an upper surface of said platform so that the second above-platform article-mount is swivelable on said upper surface, wherein said second above-platform article-mount comprises a bracket with two parallel, upending arms having a vertical space between them for receiving a cargo item.

8. The load carrier of claim 7, wherein said second above-platform article-mount comprises a plate that is at or near the upper surface of the platform and to which said bracket is attached, wherein the plate is adjustably fixed to the platform by at least one bolt extending through at least one hole in the plate and into any of a plurality of holes in said platform, and wherein the plate, when unbolted from the platform, is rotatable in a horizontal plane to swivel said second above-platform article-mount on said upper surface.

9. The load carrier of claim 7 comprising a total of two of said second above-platform article-mounts connected to the upper surface of said platform and spaced apart from each other above the platform so that said two of the second above-platform article-mounts are adapted to opposite ends of an elongated cargo item.

10. The load carrier as in claim 1, wherein said platform is rectangular in shape.

11. The load carrier as in claim 1, wherein said platform is generally oval in shape.

12. The load carrier as in claim 3, wherein said platform is rectangular in shape.

13. The load carrier as in claim 3, wherein said platform is generally oval in shape.

14. The load carrier as in claim 9, wherein said platform is rectangular in shape.

15. The load carrier as in claim 9, wherein said platform is generally oval in shape.

16. The load carrier as in claim 1, wherein said platform has a front edge for facing toward the front end of a vehicle, a rear edge for facing rearward on the vehicle, and a length between said front edge and said rear edge, and wherein said first below-platform article-mount bottom end has a horizontal length, and wherein said top end is connected to the platform in an orientation that places the horizontal lengths of both of said top end and said bottom end parallel to the length of the platform.

17. The load carrier as in claim 3, wherein said platform has a front edge for facing toward the front end of a vehicle, a rear edge for facing rearward on the vehicle, and a length between said front edge and said rear edge, and wherein said two of the second below-platform article-mounts are connected to said platform in a row parallel to the length of the platform.

18. The load carrier as in claim 17, and spaced apart from each other underneath the platform so that said two of the second below-platform article-mounts are adapted to opposite ends of an elongated cargo item.

19. A load carrier for mounting to an off-road vehicle having a front, rear, and a length, the load carrier comprising:
a platform having at least a portion that is substantially flat and on a generally horizontal plane;
a first above-platform article-mount connected to an upper surface of said platform so that the first above-platform article-mount is swivelable on a vertical axis to multiple orientations on said upper surface and lockable in said multiple orientations, wherein said first above-platform article-mount comprises two parallel, upending paddles having a vertical space between them for receiving a cargo item.

20. The load carrier as in claim 19, further comprising a first below-platform article-mount extending downward from the platform, said first below-platform article-mount comprising: a top end and a bottom end, wherein the top end is connected to the platform and has a generally horizontal length, wherein said top end and bottom end each comprise hooked portions facing each other for capturing a snowboard between said hooked portions for suspending the snowboard from the platform in an orientation generally parallel to a length of the vehicle, and wherein the top end is adjustably connected to the platform so that the first below-platform article-mount is horizontally adjustable relative to the platform in a direction parallel to the length of the top end.

21. The load carrier of claim 19, wherein said first above-platform article-mount comprises a plate that is at or near the upper surface of the platform and to which said paddles are attached, wherein the plate is adjustably fixed to the platform by at least one bolt extending through at least one hole in the plate and into any of a plurality of holes in said platform, and wherein the plate, when unbolted from the platform, is rotatable in a horizontal plane to swivel said above-platform article-mount on said upper surface.

22. A load carrier for mounting to an off-road vehicle having a front, rear, and a length, the load carrier comprising:
a platform having at least a portion that is substantially flat and on a generally horizontal plane, and having a recessed portion below said generally horizontal plane, the platform having a front edge for facing the front end of the vehicle and a rear edge for facing the rear end of the vehicle, and a length between said front edge and said rear edge;
a first above-platform article-mount connected to an upper surface of said platform so that the first above-platform article-mount is swivelable on a vertical axis to multiple orientations on said upper surface and lockable in said multiple orientations, wherein said first above-platform article-mount comprises two parallel, upending paddles having a vertical space between them for receiving a first elongated cargo item;
a first below-platform article-mount comprising a bracket having a top rail end adjustably connected to the platform and extending down from the platform, said bracket further having a lower cradle end with a horizontal wall for suspending a second elongated cargo item below the platform;
wherein both of said first above-platform article-mount and said first below-platform mount are oriented generally parallel to the length of the platform for holding said first and second elongated cargo items generally parallel to the lengths of the platform and vehicle.

23. A load carrier for mounting to an off-road vehicle having a front, rear, and a length, the load carrier comprising:
a platform having at least a portion that is substantially flat and on a generally horizontal plane, and having a recessed portion below said generally horizontal plane, the platform having a front edge for facing the front end of the vehicle and a rear edge for facing the rear end of the vehicle, and a length between said front edge and said rear edge;
an above-platform article-mount comprising a generally disc-shaped base plate, with the base plate being adjustably connected to the load carrier top surface so that the above-platform article-mount is swivelable on an vertical axis, and with the base plate further supporting at least one post- or paddle-shaped upright member for securing of cargo items to said at least one post- or paddle-shaped upright member.

24. The load carrier of claim 23, wherein the above-platform comprises two of said post- or paddle-shaped upright members and the load carrier further comprises a device to force said two upright members toward each other to clamp a cargo item between said two upright members.

25. The load carrier of claim 24, wherein at least one of said two upright members is removable from the disc-shaped base plate and the load carrier further comprises a detachable handle attachable to said at least one of said two upright members for use as an improvised snow shovel.

26. The load carrier of claim 24, wherein said two upright members are removable from the disc-shaped base plate and the load carrier further comprises shoe-binding mechanisms that are attachable to said two upright members for use of the two upright members as improvised snow-shoes.

27. The load carrier of claim 23, further comprising a hinged and latchable lid covering said recessed portion.

28. The load carrier of claim 23 comprising a strut that extends from the platform, at or near the rear edge of the platform, said strut having at least one foot for being strapped to a grab bar or bumper of the vehicle.
